(19) United States
(12) Patent Application Publication
(10) Pub. No.: US 2007/0236955 A1
(43) Pub. Date: Oct. 11, 2007

(54) LIGHTING APPARATUS HAVING A LIGHTING COMPONENT HOLDER

(75) Inventor: James A. Fowler, Bradford (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: OPTILUME LTD, Ilkley (GB)

(21) Appl. No.: 11/691,107

(22) Filed: Mar. 26, 2007

(30) Foreign Application Priority Data
Apr. 6, 2006 (GB) GB0606940.5

(51) Int. Cl. F21V 9/00; G02B 6/04

(52) U.S. Cl. 362/554; 362/293; 362/96

(57) ABSTRACT

A lighting apparatus includes a thermally decoupled lighting component holder. The component holder includes a component holder body defining a fiber optic receptacle and a light source receptacle. The fiber optic receptacle is disposed in the lighting apparatus housing, and has an internal surface configured to retain at least a portion of a fiber optic cable. The light source receptacle is disposed in the lighting apparatus housing apart from the fiber optic receptacle by a predetermined distance so that the fiber optic receptacle is at least partially thermally decoupled from the light source receptacle. Such a light source receptacle has an internal surface configured to retain at least a portion of a light source that is disposed within the light source receptacle. The fiber optic receptacle and light source receptacle are arranged so that light emitted from said light source is directed into the light receiving end of the fiber optic cable.

### CROSS-REFERENCE TO RELATED APPLICATIONS

This United States patent application claims the benefit of United Kingdom Patent Application GB0606940.5, which was filed on Apr. 6, 2006, and which is incorporated herein in its entirety.

### BACKGROUND OF THE INVENTION

I. The Field of the Invention

The present invention relates to a lighting apparatus having a component holder that is configured to hold different components apart from each other. Additionally, the present invention relates to the component holder having a fiber optic chamber and a light source chamber, and being configured such that the fiber optic chamber and light source chamber are spaced apart at a pre-determined distance and arranged such that light from the light source is directed into the fiber optic cable.

II. The Related Technology

Lighting devices are commonly used in various applications so that an object can be illuminated so as to become visible or to enhance the visibility of the object. However, many lighting devices are configured for specific uses such that there is limited cross-compatibility between different types of lighting devices. One such lighting device and use that restricts cross-compatibility with other lighting devices is a loupe light for use in dental or surgical settings. A loupe light is typically used with high magnification loupes (e.g., magnification glasses, magnification viewers, etc.) so that a dental or surgical professional can view a subject with enhanced visibility and/or clarity during a dental or surgical procedure. Loupes and loupe lights are often used by jewelers, watch craftsmen, or other tradesmen that view objects under magnification.

A loupe light generally directs light toward the object that is to be magnified and viewed through the loupe. As such, the loupe light is often positioned relative to the loupe magnification lens so that the light does not pass directly through the loupe magnification lens. This can include orienting the loupe light laterally or radially from the loupe magnification lens or at a position on the object-side of the magnification lens. Usually, the loupe light is not disposed so as to shine the light directly through the loupe magnification lens because of spectral reflection, diffraction, or the like which can interfere with the visual quality of the object being illuminated.

For example, dental loupe lights are used to provide a directed source of light in a patient's mouth to aid the dental professional while performing a dental procedure. Dental loupe lights typically include a lighting device having a housing with a light source contained therein and powered by a power supply. Often, a fiber optic cable runs from the light source of the dental loupe light to one or a pair of high magnification loupes worn by the dental professional. As such, the outlet end or light emission end of the fiber optic cable is positioned on the glasses worn by the dental professional so as to direct a focused beam of light into the patient's mouth.

However, one problem associated with known dental loupe lights is that the housing of the light source is typically secured to a bench adjacent the dental professional so as to be fixed, which is typically due to the size and design of the light source. By being fixed or having poor design, the movement of the dental professional is restricted during the dental procedure. Additionally, the fiber optic cable often impedes the ability of the dental professional to move or manipulate various instruments during the dental procedure, which can result in the fiber optic cable being damaged or otherwise compromised. Furthermore, lighting devices usually generate a substantial amount of heat, which has resulted in the placement being fixed and/or remote from the loupe magnification lens. In part, this is because the heat generated from the light source causes the housing to become hot, which can injure a dental professional who becomes too close or accidentally touches the housing.

Accordingly, it would be beneficial to have a lighting apparatus that includes a light source that is thermally decoupled from the light source housing. Also, it would be beneficial for the lighting apparatus to include a cooling apparatus so that the temperature of the light source housing would be held below a potentially dangerous or harmful temperature. Additionally, it would be beneficial to have a lighting apparatus configured such that various optical components, such as a light source and fiber optic cable, are separated by a pre-determined distance and arranged such that light from the light source is directed into the fiber optic cable. Furthermore, it would be beneficial for the apparatus to be portable and/or usable with a loupe that was portable.

### BRIEF SUMMARY OF THE INVENTION

Embodiments of the present invention include a lighting apparatus, lighting apparatus component holder, and methods of use thereof. The lighting apparatus can include a housing that is thermally decoupled from a light source disposed therein. Also, embodiments of the present invention can be configured to be self-cooling so that the temperature of the lighting apparatus housing is held below a potentially dangerous or harmful temperature. Additionally, embodiments of the present invention can be configured such that various optical components, such as a light source and fiber optic cable, are separated by a pre-determined distance and arranged such that light from the light source is directed into the fiber optic cable. Furthermore, embodiments of the present invention include methods of using the lighting apparatus for illuminating objects for enhanced visual clarity.

In one embodiment, the present invention includes a lighting component holder for use in a lighting apparatus. The component holder is comprised of a component holder body defining a fiber optic receptacle and a light source receptacle. The component holder is disposed in a lighting apparatus housing and is at least partially thermally decoupled from the lighting apparatus housing. The fiber optic receptacle is disposed in a first location within the lighting apparatus housing, and has an internal surface configured to retain at least a portion of a fiber optic cable that is disposed within the fiber optic receptacle. Such a fiber optic cable includes a light receiving end disposed in the fiber optic receptacle opposite of a light emitting end. The light source receptacle is disposed in a second location within the lighting apparatus housing, and the second location is spaced apart from the first location by a predetermined distance so that the fiber optic cable is at least partially thermally decoupled from the light source. Such a light source receptacle has an internal surface configured to retain at least a portion of a light source that is disposed within the light source receptacle. The fiber optic receptacle and light source receptacle are arranged so that light emitted from said light source is directed into the light receiving end of the fiber optic cable.

In one embodiment, the present invention includes a lighting apparatus comprised of the lighting apparatus housing and the component holder as described herein. The component holder can be configured such that a light emitting end of the fiber optic cable is oriented so as to emit light out of the lighting apparatus housing.

In one embodiment, a majority of the external surface of the component holder is spaced a distance apart from an interior surface of the lighting apparatus housing. Such a space can be filed with air, insulation, or other material that can thermally decouple the lighting apparatus housing from the light source.

In one embodiment, the fiber optic receptacle is associated with a front surface of the component holder body and the light source receptacle is associated with a rear surface of the component holder body. Also, the fiber optic receptacle can be disposed opposite of the light source receptacle within the component holder body.

In one embodiment, the component holder body is further comprised of at least one of the following: a filter receptacle containing at least a portion of a movable or rotatable filter device disposed between the fiber optic receptacle and the light source receptacle; a fan receptacle containing at least a portion of a fan disposed laterally from the fiber optic receptacle and/or the light source receptacle or disposed in a front surface or back surface of the component holder body; an electronic component receptacle containing at least a portion of an electronic component disposed in a top surface of the component holder body; a thermocouple receptacle containing at least a portion of a thermocouple disposed on or in an external surface of the component holder body; or a printed circuit board receptacle containing at least a portion of a printed circuit board disposed in a top surface of the component holder body.

In one embodiment, the lighting apparatus and/or component holder includes a cooling means for cooling the component holder and/or housing. For example, such a cooling means can include at least one of the following: at least one channel extending from an opening in the external surface of the component holder to an opening of the internal surface of the fiber optic receptacle; at least one channel extending from an opening in the external surface of the component holder to an opening of the internal surface of the light source receptacle; at least one channel extending from an opening in the external surface of the component holder to an opening in the filter receptacle; at least one channel extending from an opening in a surface of the component holder to an opening in the fan receptacle; at least one channel extending from an opening in a surface of the component holder to an opening in the electronic component receptacle; at least one channel extending from an opening in a surface of the component holder to an opening in the printed circuit board receptacle; a temperature measuring means for measuring the temperature of air disposed between the lighting apparatus housing and the component holder body; a fan; or a thermocouple in communication with a processing means that is in communication with and controls a fan, wherein the thermocouple measures the temperature of air disposed between the lighting apparatus housing and the component holder body and provides temperature data to the processing means that controls the fan in response to the temperature data.

In one embodiment, the present invention is characterized by at least one of the following: the filter device is comprised of at least one filter selected from the group consisting of an ultraviolet filter, an infrared filter, an orange filter, a polarizer filter, wavelength filter, long-pass filter, short-pass filter, tunable filter, and combinations thereof, the light source is a halogen or high-intensity discharge light; or the fiber optic cable is comprised of a single fiber, a fiber bunch, or a plurality of fiber bunches.

In one embodiment, the lighting apparatus housing is removably couplable with an object configured to be worn on a body of a person. This can include the housing being removably couplable with a belt, necklace, headband, armband, fanny-pack, backpack, article of clothing, or the like.

In one embodiment, the lighting apparatus includes a fastener disposed at the light emitting end of the fiber optic cable. Such a fastener can be any member selected from the group consisting of a friction fit, at least one clamp, an adhesive, a welding, an elastic band, at least one clip, at least one tie, inter-engaging members, a screw, a bolt, a cotter pin, and combinations thereof.

In one embodiment, the fiber optic cable has a length sufficient to extend from the lighting apparatus housing to a frame of spectacles. Also, the fastener can be configured to couple the light emitting end of the fiber optic cable to the frame of the spectacles.

In one embodiment, the lighting apparatus is comprised of at least one battery contained in a battery receptacle that is disposed within the lighting apparatus housing. The battery can be electronically coupled with the light source. Also, a battery charger can be associated with the lighting apparatus housing and electronically coupled with at least one battery.

In one embodiment, the lighting apparatus includes a lens housing defining at least one lens receptacle. As such, each lens receptacle can include a lens. The lens housing can be disposed at the light emitting end of the fiber optic cable so that light emitted from the light emitting end passes through at least one lens.

In one embodiment, the lighting apparatus includes at least one aperture defined by the lighting apparatus housing such that air passes into and circulates within the lighting apparatus housing. The apertures can be included in any portion of the lighting apparatus housing. Optionally, the apertures can be associated with fans that can facilitate the induction of air into the housing and circulation within the housing.

In one embodiment, the lighting apparatus housing has a shape and size that is portable. By being portable, the lighting apparatus can be manually maneuvered or manipulated by hand. As such, the lighting apparatus can be hand-held.

In one embodiment, the lighting apparatus can have a shape and size of a dental loupe. Dental loupes have various shapes and sizes to which the lighting apparatus can be configured.

These and other embodiments and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is an illustration that depicts a side view of an embodiment of a lighting apparatus having a component holder.

FIG. 1B is an illustration that depicts a front view of the lighting apparatus of FIG. 1A.

FIG. 2A is an illustration that depicts a side view of an embodiment of a component holder that can be disposed within the lighting apparatus as in FIGS. 1A-1B.

FIG. 2B is an illustration that depicts a front view of the component holder of FIG. 2A.

FIG. 2C is an illustration that depicts a cross-sectional side view of the component holder of FIG. 2A.

FIG. 2D is an illustration that depicts a rear view of the component holder of FIG. 2A.

FIG. 3 is an illustration that depicts an embodiment of a filter wheel for use with the present invention.

FIG. 4 is an illustration that depicts an embodiment of a lens assembly for use with the present invention.

### DETAILED DESCRIPTION OF THE PREFERRED EMBODIMENTS

Generally, embodiments of the present invention include a lighting apparatus containing a component holder that is thermally decoupled from the lighting apparatus housing. Also, embodiments of the present invention include a cooling system so that the temperature of the lighting device housing is held below a potentially dangerous or harmful temperature. Additionally, embodiments of the present invention include a lighting apparatus configured such that a various optical components, such as a light source and fiber optic cable, are separated by a pre-determined distance and arranged such that light from the light source is directed into the fiber optic cable. Furthermore, embodiments of the present invention can be portable and/or usable with a loupe.

### I. Lighting Apparatus

In one embodiment, the present invention includes a lighting apparatus having a component holder disposed therein. The component holder is disposed in a lighting apparatus housing and is at least partially thermally decoupled from the lighting apparatus housing. Such a lighting apparatus and/or component holder can be configured to have receptacles for retaining various components within a housing of a lighting apparatus. Also, the lighting apparatus can be configured to have an increased cooling potential. Further, the lighting apparatus can be configured to be portable or hand-held so that it can be used in a variety of settings compared to a lighting apparatus that is big, bulky, or fixed in a location. Also, the lighting apparatus and component holder can be configured such that the light emitting end of the fiber optic cable is oriented so as to emit light out of the lighting apparatus housing.

The lighting apparatus housing can be comprised of any material that can be fashioned as described herein. Additionally, the lighting apparatus housing can be configured to have insulating features so that heat generated by lighting components is inhibited from being transferred through the lighting apparatus housing. Examples of suitable materials that can be configured to be insulating include wood, plastics, ceramics, composites, and the like. Also, various metals and alloys can be employed in some embodiments, such as those that include a cooling system.

In one embodiment, the external surface of the component holder is spaced a distance apart from an interior surface of the lighting apparatus housing. Such a space can be filed with air, insulation, or other insulating material that can thermally decouple the lighting apparatus housing from the light source. Also, the component holder can be directly or indirectly coupled to an internal surface of the lighting apparatus housing. Various fasteners and fastening means can be used to orient the component holder within the lighting apparatus housing.

In one embodiment, a majority of the external surface of the component holder is spaced a distance apart from an interior surface of the lighting apparatus housing. As such, most of the external surface of the component holder does not contact the lighting apparatus housing so as to at least partially thermally decouple the component holder from the lighting apparatus housing. As such, a portion of the component holder external surface can be in contact with the internal surface of the lighting apparatus body so as to orient the two structures with respect to each other, but the amount of contact does not transfer substantial heat to the lighting apparatus housing. This arrangement can be beneficial in regulating the temperature of the lighting apparatus housing.

In one embodiment, the lighting apparatus is comprised of at least one battery contained in a battery receptacle that is disposed within the lighting apparatus housing. Such a battery can be disposable or rechargeable, and can be electronically coupled with the light source. Rechargeable batteries can be electronically coupled with a recharging unit associated with the lighting apparatus, and/or couplable with a power source. The battery charger can be associated with the lighting apparatus housing and electronically coupled with at least one battery. Battery and recharging unit configurations for use in devices that use electricity are well known in the art.

In one embodiment, the lighting apparatus includes a lens housing defining at least one lens receptacle. Each lens receptacle can include any type of lens. The lens housing can be disposed at the light emitting end of the fiber optic cable so that light emitted from the light emitting end passes through at least one lens. For example, the lens can be a passive, biplanar, biconvex, plano-convex, convex-concave, meniscus, plano-concave, biconcave, and the like. As such, the light can passively pass through the lens or converge, concentrate, focus, diverge, spread, collimate, or the like. The lens housing can include a fiber optic fastener for engaging the fiber optic cable thereto. The fiber optic fastener can also ensure the fiber optic cable is located at a pre-determined distance from the one or more lenses used in the lens housing.

In one embodiment, the lighting apparatus includes at least one aperture defined by the lighting apparatus housing. The aperture can allow air to pass into and out from the lighting apparatus housing and can allow air to circulate within the lighting apparatus housing. The aperture can be included in any portion of the lighting apparatus housing. Also, the aperture can be associated with a cooling channel defined by the component holder body, which can allow heated air to pass into and out of the component holder body. Optionally, the aperture can be associated or aligned with a fan that can facilitate the induction of air into the housing and circulation within the housing.

In one embodiment, the lighting apparatus housing has a shape and size so as to be portable. By being portable, the lighting apparatus can be manually maneuvered or manipulated by hand. As such, the lighting apparatus can be small enough to be hand-held. Various shapes and sizes of hand-held devices are well known and can be modulated to accommodate the lighting apparatus of the present invention. For example, the lighting apparatus can be of a shape and size suitable for being coupled to an object that can be worn, or small enough to be placed within a pocket of an article of clothing.

In one embodiment, the lighting apparatus housing is removably couplable with an object configured to be worn on a body of a person. This can include the housing being removably couplable with a belt, necklace, headband, armband, vision spectacles, fanny-pack, backpack, article of clothing, or the like. As such, the lighting apparatus can be coupled to such an object and worn during use. Alternatively, the lighting apparatus can be permanently coupled to or integrated with such an object.

In one embodiment, the lighting apparatus includes a fastener disposed at the light emitting end of the fiber optic cable. Such a fastener can be any member selected from the group consisting of a friction fit, at least one clamp, an adhesive, a welding, an elastic band, at least one clip, at least one tie, inter-engaging members, a screw, a bolt, a cotter pin, combinations thereof, and the like. Also, the fastener can be included with a fastener housing that is coupled to the fiber optic cable or enclosed around the fiber optic cable. Optionally, the fastener can be coupled to a lens housing. In any event, the light emitting end of the fiber optic cable can be configured so as to be couplable with various objects, such as those that can be worn as described above. For example, the fastener can be configured to couple the light emitting end of the fiber optic cable to the frame of vision spectacles.

In one embodiment, the lighting apparatus housing includes a fiber optic aperture and a fiber optic cable of a length sufficient to extend out from the lighting apparatus through the fiber optic aperture. Also, the length of fiber optic cable extending from the fiber optic aperture can be of sufficient length so that the light emitting end can be maneuvered and pointed at an object in need of being illuminated. This can allow a person using the lighting apparatus to point or direct the light emitting end of the fiber optic cable in any direction. Also, this can allow for the light emitting end to extend to a remote location, such as to a frame of vision spectacles.

In one embodiment, the lighting apparatus can have a shape and size of a loupe, such as a surgical loupe, dental loupe, jeweler loupe, or other loupe. Such loupes have various shapes and sizes to which the lighting apparatus can be configured. Loupes can be configured to be portable or fixed. Additionally, the lighting apparatus can be used to provide a light source for an illumination apparatus as described in United Kingdom Patent Application GB0619658.8, which was filed on Oct. 4, 2006, or co-pending U.S. patent application having attorney docket number 16516.3a, entitled “ILLUMINATION APPARATUS”, which patent applications are each incorporated herein in their entirety by specific reference.

### II. Component Holder

The component holder can be comprised of a component holder body. The component holder body can be comprised of any material that can be fashioned as described herein. Additionally, the component holder body can be configured to have insulating features so that heat generated by lighting components is inhibited from being transferred through the component holder body. Examples of suitable materials that can be configured to be insulating include wood, plastics, ceramics, composites, and the like. Also, various metals and alloys can be employed in some embodiments, such as those that include a cooling system.

The component holder body can be configured to include the features described herein as a single integrated body. Alternatively, the component body can be comprised of modular bodies that can be associated so as to provide the features as described herein. Also, the different modular bodies can be separate and disposed within the lighting apparatus housing in an arrangement to provide the features as described herein.

The component holder body defines a fiber optic receptacle. The fiber optic receptacle is disposed in a first location within the lighting apparatus housing, and has an internal surface configured to retain at least a portion of a fiber optic cable that is disposed within the fiber optic receptacle. This can include the internal surface having a shape and size commensurate with the fiber optic cable. Also, the internal surface can be outfitted with fasteners that can couple the fiber optic cable to the component holder body, which can include fasteners that are commonly used to associate fiber optic cables with different optical components.

The fiber optic cable includes a light receiving end disposed in the fiber optic receptacle opposite of a light emitting end. The fiber optic cable can be configured to have various lengths such that the light emitting end is disposed within or at the lighting apparatus housing and pointing out thereof through an aperture, or the light emitting end can be extended out from the lighting apparatus housing. A fiber optic cable can be comprised of a single fiber, a fiber bunch, split bundle, a plurality of fiber bunches, or the like. Also, randomized fiber optic bundles can be used since they provide substantially uniform light, and slip bundles can eliminate reflection back towards a user's eye.

The component holder body also defines a light source receptacle. The light source receptacle is disposed in a second location within the lighting apparatus housing, where the second location is spaced apart from the first location by a predetermined distance. Spacing the light source receptacle apart from the fiber optic cable can at least partially thermally decouple from the light source so that the fiber optic cable is not subjected to heat that can damage or degrade the integrity of the optical fibers. Also, the light source receptacle has an internal surface configured to retain at least a portion of a light source that is disposed within the light source receptacle. This can include the internal surface having a shape and size commensurate with the light source. Additionally, the internal surface can be outfitted with a fastener that can couple the light source to the internal surface. Furthermore, the fiber optic receptacle and light source receptacle are arranged so that light emitted from said light source is directed into the light receiving end of the fiber optic cable.

The light source can be any lamp that emits light. Such a lamp can be a halogen lamp, high intensity discharge (HID) lamp, light emitting diode (LED), array of LEDs, or the like. As such, the light source can create a significant amount of heat. The light source used in conjunction with the fiber optic cable and any focusing optics can provide a single defined beam which does not interfere with use. The light source can be configured to emit light characterized as substantially 5500 Kelvin or “noon day” sunlight. Accordingly, the light emitter can include a plurality of LEDs that cooperate to emit the light. Alternatively, the light emitter can include a halogen, HID, or other lamp that can be filtered so as to emit the light. An example of a light source can be found in U.S. patent application Ser. No. 11/339,288, which is incorporated herein in its entirety by specific reference.

In one embodiment, the fiber optic receptacle is associated with a front surface of the component holder body and the light source receptacle is associated with a rear surface of the component holder body. This can include the fiber optic receptacle and/or light source receptacle being disposed on or formed into the component holder body. These receptacles can be affixed to the internal surface of the component holder body, and oriented adjacent thereto. Also, the fiber optic receptacle can be disposed opposite of the light source receptacle within the component holder body. This can include the fiber optic receptacle being disposed in a front end of the component holder body and the light source receptacle being disposed in a back end of the component holder body. However, other arrangements can be used as described herein.

In one embodiment, the component holder body includes or defines at least one filter receptacle. Each filter receptacle can be configured so as to retain at least a portion of a filter or filter device. In some instances a single filter is disposed in the filter receptacle, and in other instances a movable or rotatable filter device having a plurality of filters is disposed in the filter receptacle. Such a filter device can include a plurality of filters arranged so that the filter device can be moved or rotated to change from one filter to another. The filter receptacle can be positioned within a light path such that light emitted from the light source passes through the filter receptacle and through at least one filter or empty aperture before being emitted from the lighting apparatus. Usually, the filter receptacle having at least one filter is disposed between the fiber optic receptacle and the light source receptacle such that light emitted from the light source passes through a filter before being directed into the light receiving end of the fiber optic cable.

The filter device included with the component holder can be configured to be movable or rotatable with respect to the filter receptacle. The filter device typically allows one or more filters to be moved relative to the light source so that the quality or characteristics of the light emitted from the lighting device can be modulated. In the instance the filter device is rotatable, the filter receptacle can include a slot to retain at least a portion of the filter device. The axis of rotation of a rotatable filter device can be oriented between the front and rear surface of the component holder, or the axis of rotation can be congruent with the light emitted from the light source. As such, the filter device can be oriented substantially orthogonal to the light source so that light can pass through a filter or aperture located in the filter device. This allows for the selection of a particular filter over other filters located in the filter device. A movable filter device can be similarly configured.

Accordingly, one or more filters can be fixedly attached to the filter device in a manner that light emitted from the light source can pass through a selected filter. Usually, each filter is disposed within a filter aperture defined by the filter device. Any of the filters can be selected from the group consisting of an ultraviolet filter, an infrared filter, an orange filter, a filter that filters out blue light, a polarizer filter, wavelength filter, long-pass filter, short-pass filter, tunable filter, combinations thereof, and the like.

In one embodiment, the component holder body includes or defines at least one fan receptacle. Each fan receptacle can be configured so as to retain at least a portion of a fan. The fan receptacle can be oriented laterally from the fiber optic receptacle and/or the light source receptacle so that the fan is not disposed in the light path emitted by the light source. This can include the fan receptacle being disposed on or defined by the body of the component holder body. As such, the fan receptacle can be disposed in a surface of the component holder body, such as the front surface, back surface, top surface, bottom surface, or any side surface. Also, the fan receptacle can be configured similar to an aperture so that air can be drawn into and/or around the component holder.

The fan can be any air moving device that can circulate air into and out of the component holder. This can include fans oriented so as to create a negative pressure differential and/or a positive pressure differential with respect to the component holder and/or interior of lighting apparatus housing with respect to the outside air. Also, the fan can be of various sizes, such as the size of fans commonly used to cool computer CPUs or other electronic devices.

In one embodiment, the component holder body includes or defines at least one electronic component receptacle. Such an electronic component can be any hardware that operates with electricity to drive a function of the lighting device. Each electronic component receptacle can be configured so as to retain at least a portion of a electronic component. The electronic component receptacle can be oriented laterally from the fiber optic receptacle and/or the light source receptacle so that the electronic component is not disposed in the light path emitted by the light source. This can include the electronic component receptacle being disposed on or defined by the body of the component holder body. As such, the electronic component receptacle can be disposed in a surface of the component holder body, such as the front surface, back surface, top surface, bottom surface, or any side surface.

In one embodiment, the component holder body includes or defines at least one thermocouple receptacle. Such a thermocouple can be any temperature measuring device that can communicate temperature data to a computing system that can process the temperature data to control the temperature of the component holder and/or lighting apparatus. Each thermocouple receptacle can be configured so as to retain at least a portion of a thermocouple. The thermocouple receptacle can be oriented laterally from the fiber optic receptacle and/or the light source receptacle so that the thermocouple is not disposed in the light path emitted by the light source. This can include the thermocouple receptacle being disposed on or defined by the body of the component holder body. As such, the electronic component receptacle can be disposed in a surface of the component holder body, such as the front surface, back surface, top surface, bottom surface, or any side surface. Also, the thermocouple receptacle can be disposed on an internal surface or external surface of the component holder body.

In one embodiment, the component holder body includes or defines at least one printed circuit board (PCB) receptacle. Such a PCB can be any circuit board that operates a function of the lighting device. For example, the PCB can include circuitry and/or electronic components that receive temperature data from the thermocouple and process the temperature data to control the temperature of the component holder and/or lighting apparatus. Each PCB receptacle can be configured so as to retain at least a portion of a PCB. The PCB receptacle can be oriented laterally from the fiber optic receptacle and/or the light source receptacle so that the PCB is not disposed in the light path emitted by the light source. This can include the PCB receptacle being disposed on or defined by the body of the component holder body. As such, the PCB receptacle can be disposed in a surface of the component holder body, such as the front surface, back surface, top surface, bottom surface, or any side surface. Also, the PCB receptacle can be disposed on an internal surface or external surface of the component holder body.

In one embodiment, the component holder includes a cooling means for cooling the component holder and/or housing. The cooling means can include a cooling device and/or cooling structure that is configured to cool the component holder and/or lighting apparatus. Exemplary cooling devices include a fan, thermoelectronic cooler (TEC), a temperature measuring device (e.g., thermocouple), and the like. A cooling device can be disposed between the lighting apparatus housing and the component holder body.

Also, a thermocouple can be in communication with a processor that is in communication with and controls a fan, wherein the thermocouple measures the temperature of air disposed between the lighting apparatus housing and the component holder body and provides temperature data to the processing means that controls the fan in response to the temperature data. A closed loop system is typically formed in the lighting apparatus, such that a change in temperature controls the speed of the fan means and thereby controls the temperature.

A cooling structure can include a channel or aperture in the component holder body that enables air to circulate from outside the component holder into and around the component holder. This can also include drawing air from outside of the lighting apparatus. For example, such a cooling structure can include at least one of the following: at least one channel extending from an opening in the external surface of the component holder to an opening of the internal surface of the fiber optic receptacle; at least one channel extending from an opening in the external surface of the component holder to an opening of the internal surface of the light source receptacle; at least one channel extending from an opening in the external surface of the component holder to an opening in the filter receptacle; at least one channel extending from an opening in a surface of the component holder to an opening in the fan receptacle; at least one channel extending from an opening in a surface of the component holder to an opening in the electronic component receptacle; at least one channel extending from an opening in a surface of the component holder to an opening in the printed circuit board receptacle; and the like. Accordingly, cool air can travel along any of the channels from an inlet to an outlet so as to cool the air surrounding the light source and/or component holder. The channels can be provided at acute angles or sloped angles so that cool air is directed onto a pre-determined position onto and/or adjacent to the light source.

### III. Lighting Apparatus And Component Holder

The following figures describe embodiments of a lighting apparatus and/or a component holder configured to be included in the lighting apparatus. As such, the following figures illustrate and reference various components or elements of the lighting apparatus and/or component holder. While the figures are illustrated and described in connection with a loupe embodiment, the lighting device can be configured for other uses as described herein. Accordingly, the following figures illustrate a lighting device that can be employed as a loupe light, which provides a transportable or portable light source that can be attached to magnification loupes (not shown) used in dentistry, surgery, or the like.

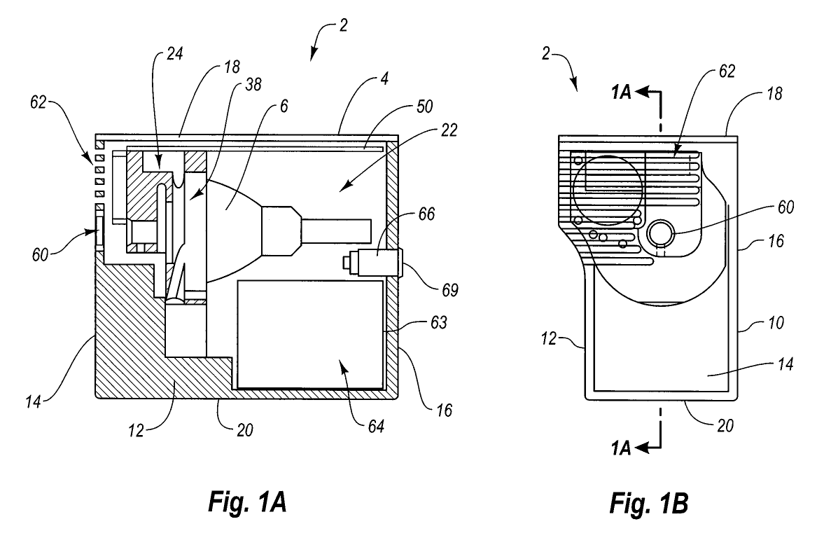

FIGS. 1A-1B illustrate an embodiment of a lighting apparatus 2 in accordance with the present invention. As shown, the lighting apparatus 2 includes a housing 4 containing a light source 6 in the form of an HID lamp. The housing 4 has side walls 10, 12, end walls 14, 16, top 18, and base 20. A cavity 22 is defined by the housing 4, and a component holder 24 is disposed within the cavity 22

A first end of a fiber optic cable (not shown) is optically coupled with the lamp 6 in housing 4 so that light emitted from the lamp 6 is directed into the fiber optic cable. A second end of the fiber optic cable extends through an aperture 60 in the housing 4.

A plurality of venting slots 62 are provided in end walls 14, 16 of the housing 4, wherein such venting slots 62 can extend through the housing 4. As such, the venting slots 62 can allow cool air to circulate through the housing 4, and can allow warm air to be exhausted from the housing 4. Also, the venting slots 62 can be part of a cooling system and can be associated with a fan and/or channels in the component holder 24. Additional vent slots can be included in any portion of the housing 4.

The housing 4 is configured to include a battery cavity 63 that can contain a battery 64 disposed therein. As such, the battery cavity 63 can be a battery receptacle and can be shaped so as to conform to a battery 64. In the instance the battery 64 is rechargeable, the housing 4 can be configured to include a battery recharging unit 66 that is in electronic communication with the battery 64. Also, the battery charging unit 66 can include a socket arrangement 69 located in the end wall 16. Since the lighting apparatus 2 can be battery powered, lighting apparatus 2 can be easily carried and does not restrict use to a particular location. The lighting apparatus 2 can also be configured to receive electricity from a standard power outlet or power supply.

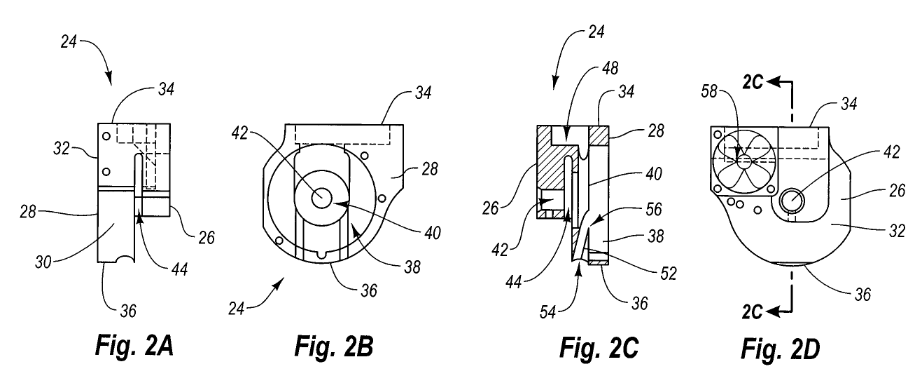

FIGS. 2A-2D illustrate an embodiment of a component holder 24 in accordance with the present invention. The component holder 24 is configured as a single integral holder that is configured to be disposed within the housing 4 of the lighting apparatus 2 described in FIGS. 1A-1B. The component holder 24 can be secured or otherwise fastened within the housing 4 with any suitable fastener, such as the fasteners described herein. The component holder 24 can also be suspended from a partition wall (not shown) located in the housing 4, where such a partition wall can be substantially insulating so as to thermally decouple the component holder 24 from the housing 4. As shown, the component holder 24 has a first end 26, second end 28, side walls 30, 32, a top 34, and base 36.

The second end 28 has a recess 38 defined therein that is configured as a receptacle for the front end of the lamp 6 so as to be a light source receptacle. In front of the recess 38 is an additional recess 40 that can be utilized as a spacer or as a receptacle for a component. For example, additional recess 40 can be used for a lens, insulator, air space, a filter, a filter device, or the like. As shown, the recess 40 opens out adjacent to the base 36 and/or sides 30, 32 of the component holder 24. Also, the recess 40 can open so as to be adjacent to the base 20 and/or sides 14, 16 of the housing 4 of the lighting apparatus 2.

Additionally, the component holder 24 includes an aperture 42 that is defined in first end 26 for the location of a portion of the fiber optic cable (not shown). As such, the light receiving end of the fiber optic cable can be secured in the aperture 42 with any suitable fastener so that receiving end is configured as a fiber optic receptacle. For example, the fastener can be a friction fit, adhesive, a clip, a tie, or the like. The aperture 42 is located substantially opposite to the recess 38 with respect to light emitted from the lamp 6 so that light passes through the recess 38 into the aperture 42 and through the fiber optic cable. In the illustrated embodiment, aperture 42 is substantially smaller than aperture 38 in which the front end of lamp 6 is located in use.

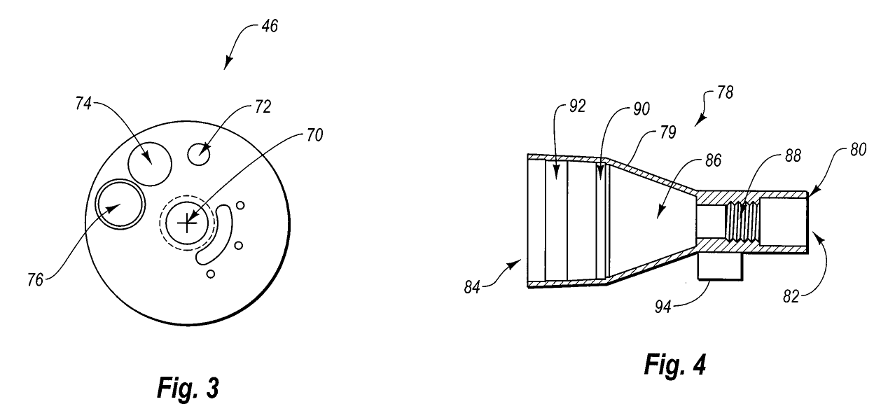

Additionally, the component holder includes a slot 44 that is disposed between the aperture 42 and the additional recess 40. The slot 44 is also oriented with respect to the recess 38 so as to be at least partially aligned therewith for the location of a filter wheel 46 (see FIG. 3). This orientation can allow light emitted from the lamp 6 to pass through or out of the recess 38, through the additional recess 40, and through the slot 44 into the aperture 42. This can include the light passing through a filter of the filter wheel 46.

A recess 48 is defined in the top wall 34 of the component holder 24 for the location of a printed circuit board (PCB) 50 (see FIG. 1A). The PCB 50 can include a temperature sensor (not shown) to allow the temperature of the component holder 24 and/or air surrounding the component holder to be measured. The temperature sensor communicates with a processor and/or a fan to control the fan to turn on/off or control the speed of the fan depending on the measured temperature. Also, the PCB can include or be coupled with other electronic components as described herein.

A channel 52 is defined in the base 36 of the component holder 24 so as to allow air to pass into and out from the component holder 24. As such, the channel 52 includes an inlet 54 defined in base 36 and an outlet 56 defined adjacent to the recess 38. The channel 52 can allow cool air to be transported into the component holder 24 and adjacent to the front of the lamp 6.

A fan 58 can be located in the component holder 24 adjacent to the first end 26 or second end 28 as shown. As illustrated in FIG. 2D, the fan 58 can be oriented in a position in the second end 28 that allows cool air to be drawn into the back of the component holder 24. Alternatively, the fan 58 can be disposed adjacent to channel 52 so that cool air can be drawn through channel 52 and to be circulated around the component holder 24. When disposed in the first end 26, the fan 58 can be offset or laterally located relative to aperture 42.

As illustrated in FIG. 1A, the component holder 24 is positioned in the housing 4 of the lighting apparatus 2 so as to be a spaced distance apart from the internal surface of the walls (e.g., side walls 10, 12, end walls 14, 16, top 18, and base 20) of the housing 4. Such a spaced apart orientation can inhibit heat generated by the lamp 6 disposed in the component holder 24 to be passed directly to the walls of the housing 4. Accordingly, the component holder 24 is at least partially thermally decoupled from the housing 4 so as to inhibit the temperature of the housing 4 from achieving a temperature that can be dangerous and/or damaging. As shown, component holder 24 is located a spaced distance apart from, but adjacent to, the top 18 of the housing 4 so that the PCB 50 is substantially parallel to and spaced apart from the top wall 18.

Additionally, FIG. 1A shows the fiber optic aperture 42 of component holder 24 located adjacent to end wall 14 so as to be substantially aligned with aperture 60 defined in the end wall 14 of housing 4. By being aligned, a fiber optic cable can extend from the fiber optic aperture 42 through the aperture 60 so as to pass out from the housing 4 of the lighting apparatus 2.

FIG. 3 illustrates a filter wheel 46 that can be at least partially disposed within the slot 44 of the component holder 24. Such a filter wheel 46 can be rotatably mounted in the slot 44 of the component holder 24 so as to be rotatable around a central axis 70 (e.g., an axis passing from the front surface 26 to the rear surface 28 of the component holder 24). The filter wheel 46 can include a plurality of apertures 72, 74, 76 which can be oriented so as to allow light emitted from the lamp 6 to pass therethrough. The apertures 72, 74, 76 can include the filters as described herein. As such, the filter can be selected to condition the light emitted from the lamp 6. As illustrated in FIG. 4, the filter wheel 46 has a first aperture 72 that can pass light from lamp 6 without any filter. The second aperture 74 is provided for a neutral density filter to allow dimming of the light that is emitted from lamp 6. A third aperture 76 is provided for the location of an orange filter for filtering out blue light emitted from lamp 6, which can be beneficial for use in dentistry. Additionally, an actuation means (not shown) for actuating the filter wheel 46 are associated with the housing 4 to allow a user to move between the different filters (e.g., apertures 72, 74, 76) by rotating the filter wheel.

FIG. 4 illustrates a lens housing 78 that can be disposed at the light emitting end of the fiber optic cable. As such, light emitted by the lamp 6 disposed in the component holder 24 can be directed into a light receiving end of the fiber optic cable so that it passes through the lens housing 78 before being directed to an object to be illuminated. The lens housing 78 is defined by side wall 79, a first end 80, and with a channel 86 defined by the side wall 79 that extends from the first end 80 to a second end 84. The first end 80 is configured to include a receiving portion 82 that is configured to receive the light emitting end of the fiber optic cable, and the second end 84 is configured to direct light towards an object to be illuminated.

A fiber optic fastener 88, which is illustrated to be in the form of a screw thread, is provided on the interior wall of the lens housing 78 at a pre-determined position in the channel 86. The fastener 88 is configured to allow for attaching the light emitting end of the fiber optic cable to the lens housing 78. The fiber optic fastener 88 can also ensure the fiber optic cable is disposed at a pre-determined focal distance from one or more lenses (not shown) disposed within the channel 86.

Additionally, at least one lens receptacle 90, 92 is defined in channel 86 by side wall 79. As shown, the lens receptacles 90, 92 are disposed towards the second end 84 of the lens housing 78. By being disposed at the second end 84, the lens receptacles 90, 92 can include focal lenses. For example, a meniscus lens can be disposed in the first lens receptacle 90, and a biconvex lens can be disposed within the second lens receptacle 92. Such focal lenses can allow the light emitted from the fiber optic cable to be focused into a pre-determined light beam size.

A fastener 94 can also be associated with the lens housing 78 so as to allow attachment of the lens housing 78 to an object (not shown). Alternatively, the fastener 94 can be associated with the light emitting end of the fiber optic cable. In any event, the fastener 94 fastener can be configured as described here so as to be coupled or couplable with an object that can be worn or an object that can be used in a procedure that can include using the lighting apparatus. For example, the fastener can be configured to couple the light emitting end of the fiber optic cable to the frame of the spectacles.

The lighting apparatus having the component holder as described in accordance with the present invention can be configured for use in a variety of settings. For example, the lighting apparatus can be configured to be coupled to a loupe for use in illuminating a subject or object to be viewed under magnification. This can include the lighting apparatus to be coupled with a dental loupe, surgical loupe, jewelers loupe, and the like. Additionally, it will be appreciated by persons skilled in the art that the lighting apparatus having the component holder of the present invention can be used in any suitable application.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A lighting component holder for use in a lighting apparatus comprising:
a component holder body disposed in a lighting apparatus housing and at least partially thermally decoupled from the lighting apparatus housing, said component holder body defining:
a fiber optic receptacle disposed in a first location within the lighting apparatus housing, said fiber optic receptacle having an internal surface configured to retain at least a portion of a fiber optic cable that is disposed within the fiber optic receptacle, wherein the fiber optic cable includes a light receiving end disposed in the fiber optic receptacle opposite of a light emitting end; and
a light source receptacle disposed in a second location within the lighting apparatus housing that is spaced apart from the first location by a predetermined distance, said light source receptacle having an internal surface configured to retain at least a portion of a light source that is disposed within the light source receptacle, wherein the fiber optic receptacle and light source receptacle are arranged so that light emitted from said light source is directed into the light receiving end of the fiber optic cable and so that the light receiving end of the fiber optic cable is at least partially thermally decoupled from the light source.

2. A lighting component holder as in claim 1, wherein the fiber optic receptacle is associated with a front surface of the component holder body and the light source receptacle is associated with a rear surface of the component holder body.

3. A lighting component holder as in claim 1, wherein the fiber optic receptacle is disposed opposite of the light source receptacle within the component holder body.

4. A lighting component holder as in claim 1, further comprising at least one of the following:
a filter receptacle containing at least a portion of a movable or rotatable filter device disposed between the fiber optic receptacle and the light source receptacle;
a fan receptacle containing at least a portion of a fan disposed laterally from the fiber optic receptacle and/or the light source receptacle or disposed in a surface of the component holder body;
an electronic component receptacle containing at least a portion of an electronic component disposed in a surface of the component holder body;
a thermocouple receptacle containing at least a portion of a thermocouple disposed on or in an external surface of the component holder body; or
a printed circuit board receptacle containing at least a portion of a printed circuit board disposed in a surface of the component holder body.

5. A lighting component holder as in claim 4, further comprising a cooling means for cooling the component holder and/or housing.

6. A lighting component holder as in claim 5, wherein the cooling means includes at least one of the following:
at least one channel extending from an opening in the external surface of the component holder to an opening of the internal surface of the fiber optic receptacle;
at least one channel extending from an opening in the external surface of the component holder to an opening of the internal surface of the light source receptacle;
at least one channel extending from an opening in the external surface of the component holder to an opening in the filter receptacle;
at least one channel extending from an opening in a surface of the component holder to an opening in the fan receptacle;
at least one channel extending from an opening in a surface of the component holder to an opening in the electronic component receptacle;
at least one channel extending from an opening in a surface of the component holder to an opening in the printed circuit board receptacle;
a temperature measuring means for measuring the temperature of air disposed between the lighting apparatus housing and the component holder body;
a fan; or
a thermocouple in communication with a processing means that is in communication with and controls a fan, wherein the thermocouple measures the temperature of air disposed between the lighting apparatus housing and the component holder body and provides temperature data to the processing means that controls the fan in response to the temperature data.

7. A lighting component holder as in claim 4, characterized by at least one of the following:
the filter device is comprised of at least one filter selected from the group consisting of an ultraviolet filter, an infrared filter, an orange filter, a polarizer filter, wavelength filter, long-pass filter, short-pass filter, tunable filter, and combinations thereof;
the light source is a high-intensity discharge light; or
the fiber optic cable is comprised of a single fiber, a fiber bunch, or a plurality of fiber bunches.

8. A lighting apparatus comprising:
a lighting apparatus housing;
a fiber optic cable at least partially disposed in the lighting apparatus housing; and
a component holder body containing at least a portion of the fiber optic cable and disposed in the lighting apparatus housing, said component holder being at least partially thermally decoupled from the lighting apparatus housing, and said component holder body defining:
a fiber optic receptacle disposed in a first location within the lighting apparatus housing, said fiber optic receptacle having an internal surface configured to retain at least the portion of a fiber optic cable that is disposed within the fiber optic receptacle, wherein the fiber optic cable includes a light receiving end disposed in the fiber optic receptacle opposite of a light emitting end that is oriented so as to emit light; and
a light source receptacle disposed in a second location within the lighting apparatus housing that is spaced apart from the first location by a predetermined distance, said light source receptacle having an internal surface configured to retain at least a portion of a light source that is disposed within the light source receptacle, wherein the fiber optic receptacle and light source receptacle are arranged so that light emitted from said light source is directed into the light receiving end of the fiber optic cable and emitted from the light emitting end of the fiber optic cable, and so that the light receiving end of the fiber optic cable is at least partially thermally decoupled from the light source.

9. A lighting apparatus as in claim 8, wherein a majority of the external surface of the component holder is spaced a distance apart from an interior surface of the lighting apparatus housing.

10. A lighting apparatus as in claim 8, wherein the lighting apparatus housing is removably couplable with an object configured to be worn on a body of a person.

11. A lighting apparatus as in claim 8, further comprising a fastener disposed at the light emitting end of the fiber optic cable, wherein the fiber optic cable has a length sufficient to extend from the lighting apparatus housing to a frame of spectacles and the fastener couples the light emitting end of the fiber optic cable to the frame.

12. A lighting apparatus as in claim 11, wherein the fastener includes at least one of a friction fit, at least one clamp, an adhesive, a welding, an elastic band, at least one clip, at least one tie, inter-engaging members, a screw, a bolt, or a cotter pin.

13. A lighting apparatus as in claim 8, further comprising at least one battery disposed in a battery receptacle disposed within the lighting apparatus housing and electronically coupled with the light source.

14. A lighting apparatus as in claim 13, further comprising a battery charger associated with the lighting apparatus housing and electronically coupled with the at least one battery.

15. A lighting apparatus as in claim 8, further comprising a lens housing defining at least one lens receptacle containing at least one lens, said lens housing being disposed at the light emitting end of the fiber optic cable so that light emitted from the light emitting end passes through the at least one lens.

16. A lighting apparatus as in claim 8, further comprising at least one aperture defined by the lighting apparatus housing such that air passes into and circulates within the lighting apparatus housing.

17. A lighting apparatus as in claim 8, wherein the lighting apparatus housing has a shape and size that is portable.

18. A lighting apparatus as in claim 8, wherein the lighting apparatus has a shape and size of a dental loupe.

19. A lighting apparatus as in claim 8, said component holder body further comprising at least one of the following:
a filter receptacle containing at least a portion of a movable or rotatable filter device disposed between the fiber optic receptacle and the light source receptacle;
a fan receptacle containing at least a portion of a fan disposed laterally from the fiber optic receptacle and/or the light source receptacle or in a surface of the component holder body;
an electronic component receptacle containing at least a portion of an electronic component disposed in a surface of the component holder body;
a thermocouple receptacle containing at least a portion of a thermocouple disposed on or in a surface of the component holder body; or
a printed circuit board receptacle containing at least a portion of a printed circuit board disposed in a surface of the component holder body.

20. A lighting apparatus as in claim 19, further comprising a cooling means for cooling the component holder and/or housing.

21. A lighting apparatus as in claim 20, wherein the cooling means includes
at least one of the following:
at least one channel extending from an opening in the external surface of the component holder to an opening of the internal surface of the fiber optic receptacle;
at least one channel extending from an opening in the external surface of the component holder to an opening of the internal surface of the light source receptacle;
at least one channel extending from an opening in the external surface of the component holder to an opening in the filter receptacle;
at least one channel extending from an opening in a surface of the component holder to an opening in the fan receptacle;
at least one channel extending from an opening in a surface of the component holder to an opening in the electronic component receptacle;
at least one channel extending from an opening in a surface of the component holder to an opening in the printed circuit board receptacle;
a temperature measuring means for measuring the temperature of air disposed between the lighting apparatus housing and the component holder body;
a fan; or
a thermocouple in communication with a processing means that is in communication with and controls a fan, wherein the thermocouple measures the temperature of air disposed between the lighting apparatus housing and the component holder body and provides temperature data to the processing means that controls the fan in response to the temperature data
